(19) United States
(12) Patent Application Publication
(10) Pub. No.: US 2023/0322116 A1
(43) Pub. Date: Oct. 12, 2023

(54) ELECTRIC VEHICLE, CHARGING STATION AND OPERATING METHOD

(71) Applicant: AUDI AG, Ingolstadt (DE)

(72) Inventor: Robert MIES, Stammham (DE)

(21) Appl. No.: 18/193,075

(22) Filed: Mar. 30, 2023

(30) Foreign Application Priority Data
Mar. 30, 2022 (DE) 102022107476.5

(51) Int. Cl. B60L 53/30; B60L 53/66

(52) U.S. Cl. CPC B60L 53/66; B60L 53/305; B60L 2250/16

(57) ABSTRACT

Provided is a method of operating a charging station for an electric vehicle, a charging station for an electric vehicle, and an electric vehicle.

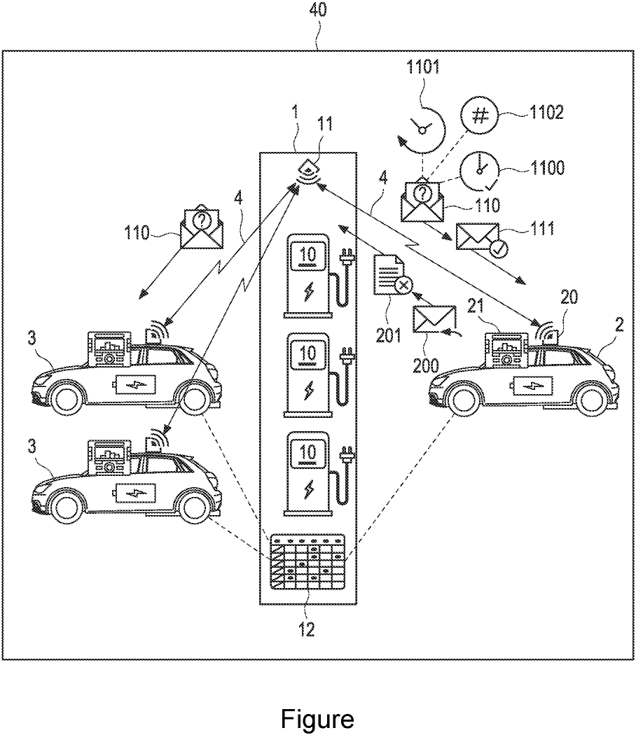

### BACKGROUND

### Technical Field

The disclosure relates to an operating method of a charging station for an electric vehicle. Moreover, the disclosure relates to a charging station for an electric vehicle and to an electric vehicle.

### Description of the Related Art

Operating methods of the kind mentioned above are part of the prior art in various configurations and they serve for charging the traction batteries of electric vehicles. The charging of a traction battery of an electric vehicle takes significantly longer than the filling of a fuel tank of a motor vehicle with a combustion engine. Accordingly, each charging of the traction battery goes hand in hand with a perceptible waiting time for the driver of an electric vehicle.

The waiting time can be further prolonged if the electric vehicle reaches a charging station intended for the charging and the charging station is occupied by another electric vehicle. It is therefore desirable to avoid an occupied charging station and instead drive to an unoccupied charging station.

For this purpose, CN 105 398 347 A discloses a method of operating a plurality of charging stations, in which a central charging server connected to the multiple charging stations determines a charging station which allows the earliest charging for the electric vehicle in dependence on the position and remaining range of the electric vehicle and in dependence on positions and operating states of the multiple charging stations among the multiple charging stations.

The charging server makes possible an earlier starting of the charging for the electric vehicle by way of a central, i.e., a global control system. Alternatively, a decentralized, i.e., a local control system of charging stations is also possible.

This approach is followed by KR 101 063 656 A1, which discloses a method of operating a plurality of charging stations, in which a charging station among the plurality of charging stations sends a recommendation message to an electric vehicle indicating another charging station among the plurality of charging stations if the charging station is occupied for a particular time and the other charging station is free before the elapsing of that particular time.

Furthermore, it is desirable to simplify the transactions connected with the charging of the traction battery, which generally require an authentication, and to improve the comfort of the charging in this way.

Thus, EP 3 656 603 A1 discloses a method of operating a charging station in which a charging station monitors by sensors a charging yard of the charging station and automatically authenticates an electric vehicle situated in the monitored charging yard.

In many cases, the driver of the electric vehicle upon approaching a charging station cannot easily ascertain whether a charging of the traction battery is possible at once or whether other electric vehicles are already waiting to be charged at the charging station. This difficulty exists in particular when the charging station has a plurality of charging ports and it cannot be ascertained at a glance whether a charging port is free.

Apart from this, conflicts may arise at the charging station between drivers of different electric vehicles as to the order in which the electric vehicles waiting to be charged should be charged.

Therefore, embodiments of the invention provide a method of operating a charging station for an electric vehicle that is simple to implement and that ensures transparency and an orderly charging of the electric vehicle. Further problems of the disclosure are to provide a charging station for an electric vehicle and an electric vehicle.

### BRIEF SUMMARY

One embodiment of the disclosure is a method of operating a charging station for an electric vehicle. The charging station as part of a charging infrastructure provides electric energy for the charging of traction batteries of electric vehicles. The more built out is the charging infrastructure, the more application possibilities there are for the disclosure.

According to the disclosure, a communication device of the charging station (1) and a communication device of an electric vehicle automatically provide a direct wireless communication link between the charging station and the electric vehicle when the electric vehicle drives into defined surroundings of the charging station, the charging station automatically sends a status message to the electric vehicle by the direct wireless communication link so provided, the electric vehicle receives the status message sent, a human/machine interface device of the electric vehicle displays the contents of the status message and the human/machine interface device queries a charging request of the electric vehicle. The electric vehicle receives the status message automatically. In this way, the charging station informs the driver of the electric vehicle as to its status, without any initiative on the part of the driver, when the electric vehicle is situated in the surroundings of the charging station.

Thanks to the status message, the driver obtains, in a comfortable manner with no action on his own part, a basis for deciding whether or not to charge the traction battery of the electric vehicle at the charging station, and information as to how much waiting time there will be for a charging of the traction battery. The status message accordingly ensures transparency regarding the charging and can make the charging at the charging station an orderly process. The direct wireless communication link enables an easy implementing of the method, since no communication network or no central control of multiple charging stations is required.

Preferably, the communication device of the charging station and the communication device of the electric vehicle provide the direct wireless communication link as a Bluetooth link and/or the range of the direct wireless communication link defines the surroundings of the charging station. The Bluetooth link is direct and wireless. The communication device of the charging station can be configured as a Bluetooth master and the communication device of the electric vehicle as a Bluetooth slave. Alternatively, the communication device of the electric vehicle can be configured as the Bluetooth master and the communication device of the charging station as the Bluetooth slave.

The Bluetooth link can have a range of up to around 100 m. Accordingly, a boundary of the surroundings of the charging station can have a distance of up to 100 m from the charging station. Consequently, the surroundings can encompass a plurality of parking places for the electric vehicle, making it possible for the electric vehicle to wait to be charged. Likewise, the plurality of parking places allows a plurality of further electric vehicles to wait to be charged.

It is noted that each message involved in the disclosure is sent or received via the direct wireless communication link. Moreover, each message can be sent or received encrypted, for example by a secure protocol or by way of a certificate.

Advantageously, the status message indicates the occupancy of the charging station and/or the status message provides a waiting list and the status message indicates a length of the provided waiting list. The status message contains information as to whether each charging port of the charging station is occupied by another electric vehicle or whether at least one charging port of the charging station is free. The length of the waiting list corresponds to the number of other electric vehicles waiting to be charged and allows the driver of the electric vehicle to estimate the waiting time required until the start of the charging.

Each electric vehicle situated in the surroundings of the charging station and connected by the direct wireless communication link to the charging station can receive the waiting list so provided. Apart from this, a terminal device, especially a smartphone with a special app of the driver can also retrieve the provided waiting list via an Internet connection and display it to the driver. Moreover, it is possible for a display screen of the charging station to show the waiting list.

Ideally, the status message indicates an arrival time of the electric vehicle as a time stamp and/or the status message indicates a presumable waiting time of the electric vehicle and/or a state of charge of another electric vehicle. The time stamp determines the order of charging for the electric vehicle. The order of charging so determined prevents another electric vehicle, arriving later at the charging station, from being charged sooner. In this way, conflicts between drivers of waiting electric vehicles are avoided. The indicated state of charge of the other electric vehicle now being charged or waiting to be charged helps the driver in estimating the waiting time until the start of the charging.

The determined order in time induces a sequence of the electric vehicles waiting at the charging station, i.e., an earlier time stamp goes hand in hand with an earlier start of the charging and a later time stamp with a later start of the charging.

In one embodiment, the electric vehicle sends a reply message to the charging station, the charging station adds the electric vehicle to the provided waiting list and the charging station sends a confirmation message to the electric vehicle if the reply message indicates a charging request of the electric vehicle. The reply message is sent on request of the driver of the electric vehicle and received by the charging station. The reply message can indicate the charging request or no charging request of the driver.

In event of no charging request, the charging station does not add the electric vehicle to the provided waiting list and the charging station sends no confirmation message to the electric vehicle. The no charging request of the driver can result, for example, from the anticipated waiting time for the charging being too long for the driver or from the electric vehicle having driven into the surroundings of the charging station with no intention of a charging.

In the case of a charging request of an electrically powered emergency vehicle, the charging station can insert the emergency vehicle ahead in the provided waiting list in order to give higher priority to the charging of the emergency vehicle. The charging station advantageously sends changed status messages to each electric vehicle pushed back on account of inserting the emergency vehicle in the waiting list.

Preferably, the electric vehicle sends a cancellation message corresponding to the confirmation message to the charging station, the charging station receives the cancellation message, the charging station deletes the electric vehicle from the provided waiting list and the charging station sends status messages which have been changed as a result of the deletion to another electric vehicle situated behind the electric vehicle in the provided waiting list. If the electric vehicle has sent a reply message indicating a charging request and after sending this the driver wants to cancel the charging, the electric vehicle at request of the driver sends the cancellation message to the charging station.

As a result of the deleting of the electric vehicle from the provided waiting list, other electric vehicles located behind the electric vehicle in the provided waiting list will be moved forward and will be informed as to this by the changed status messages.

In another embodiment, the charging station sends a changed status message to another electric vehicle situated behind the electric vehicle in the provided waiting list when the charging of the electric vehicle is finished. The finishing of the charging has the same consequences as the cancellation of a charging request.

The charging station can also send the changed status messaging to the other electric vehicle situated behind the electric vehicle in the provided waiting list if a charging of the electric vehicle does not start within a predetermined time span after the charging station becomes free or if the electric vehicle drives away from the surroundings of the charging station before starting the charging. These two cases also have the same consequences as a cancellation of a charging request.

Advantageously, the charging station provides a separate waiting list for each charging port of the charging station and the status message indicates an identifier of a charging port of the charging station. If the charging station comprises a plurality of charging ports, the driver of the electric vehicle is informed by the status message, with the aid of the identifier, as to which charging port the charging station assigns to the electric vehicle. In this way, the driver can drive the electric vehicle to the assigned charging port in the shortest way.

Of course, the charging station can change the allocation of the charging port at any time, i.e., add the electric vehicle to a different waiting list and send a further status message with a changed identifier to the electric vehicle, for example if a charging at a different charging port can start earlier on account of a cancellation of another electric vehicle.

A further embodiment of the disclosure is a charging station for an electric vehicle, comprising at least one charging port and a communication device. Such charging stations are widespread and they open up diverse application possibilities for the disclosure. In many cases, an existing charging station will have software making possible a simple configuring of the charging station.

According to the disclosure, the charging station is configured to cooperate in a method according to the disclosure. The charging station enables a transparency and an orderly charging of the electric vehicle for the driver of the electric vehicle.

Yet another embodiment is an electric vehicle, comprising a communication device and a human/machine interface device. Such electric vehicles are widespread and they open up diverse application possibilities for the disclosure. In many cases, an existing electric vehicle, and especially the human/machine interface device, will have software making possible a simple configuring of the electric vehicle. The human/machine interface device is designed in particular as a central touch-sensitive display screen (Central Information Display, CID) of an infotainment system of the electric vehicle. The human/machine interface device can comprise a microphone or a camera and be adapted to receiving acoustic or mimetic or gesticulated input.

According to the disclosure, the electric vehicle is configured to cooperate in a method according to one embodiment of the disclosure. The electric vehicle enables a transparency and an orderly charging of the electric vehicle at a charging station for the driver of the electric vehicle.

One significant benefit of the method according to the disclosure is that the charging of a traction battery of an electric vehicle at a charging station occurs in transparent and orderly manner. Accordingly, this increase the acceptance of the driver of the electric vehicle for the unavoidable charging. A further benefit is to be seen in the simple implementation.

### BRIEF DESCRIPTION OF THE SEVERAL VIEWS OF THE DRAWINGS

The disclosure is represented schematically with the aid of one embodiment in the drawings and will be further described with reference to the drawings. There is shown:

The FIGURE shows a view of a charging station according to one embodiment of the disclosure and an electric vehicle according to one embodiment of the disclosure.

### DETAILED DESCRIPTION

The FIGURE shows a view of a charging station 1 according to one embodiment of the disclosure and an electric vehicle 2 according to one embodiment of the disclosure.

The charging station 1 is suitable for the charging of the electric vehicle 2 and comprises at least one charging port 10 and a communication device 11. The charging station 1 in particular comprises a plurality of charging ports 10. The charging station 1 is configured to cooperate in a method according to one embodiment of the disclosure, which shall be described in the following.

The electric vehicle 2 comprises a communication device 20 and a human/machine interface device 21, for example an infotainment system with a touch-sensitive display screen, and it is likewise configured to cooperate in the following described method.

The method serves for the operating of the charging station 1 for the electric vehicle 2.

The communication device 11 of the charging station 1 and the communication device 20 of the electric vehicle 2 automatically provide a direct wireless communication link 4 between the charging station 1 and the electric vehicle 2 when the electric vehicle 2 drives into defined surroundings 40 of the charging station 1. The range of the direct wireless communication link 4 can define the surroundings 40 of the charging station 1.

The communication device 11 of the charging station 1 and the communication device 20 of the electric vehicle 2 provide the direct wireless communication link 4 preferably as a Bluetooth link.

The charging station 1 automatically sends a status message 110 to the electric vehicle 2 by the direct wireless communication link 4 so provided. The status message 110 can indicate the occupancy of the charging station 1. Moreover, the charging station 1 preferably provides a waiting list 12 and the status message 110 indicates a length of the provided waiting list 12.

The status message 110 can indicate an arrival time 1100 of the electric vehicle 2 as a time stamp and/or indicate a presumable waiting time 1101 of the electric vehicle 2 and/or a state of charge of another electric vehicle 3. When the charging station 1 comprises multiple charging ports 10, the status message 110 can indicate an identifier 1102 of a charging port 10 of the charging station 1.

The electric vehicle 2 receives the status message 110. The human/machine interface device 21 of the electric vehicle 2 displays the contents of the status message 110 and generates or queries a charging request of the electric vehicle 2.

The electric vehicle 2 can send a reply message 200 to the charging station 1. The charging station 1 can then add the electric vehicle 2 to the provided waiting list 12 and send a confirmation message 111 to the electric vehicle 2 if the reply message 200 indicates a charging request of the electric vehicle 2.

Moreover, the electric vehicle 2 can send a cancellation message 201 corresponding to the confirmation message 111 to the charging station 1. The charging station 1 can then receive the cancellation message 201, delete the electric vehicle 2 from the provided waiting list 12, and send status messages 110 which have been changed as a result of the deletion to another electric vehicle 3 situated behind the electric vehicle 2 in the provided waiting list 12.

Alternatively or additionally, the charging station 1 can send a changed status message 110 to another electric vehicle 3 situated behind the electric vehicle 2 in the provided waiting list 12 when the charging of the electric vehicle 2 is finished.

When the charging station 1 comprises multiple charging ports 10, the charging station 1 can provide a separate waiting list 12 for each charging port 10 of the charging station 1.

German patent application no. 102022107476.5, filed Mar. 30, 2022, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method of operating a charging station for an electric vehicle, the method comprising:
automatically providing, by the charging station and the electric vehicle, a direct wireless communication link between the charging station and the electric vehicle when the electric vehicle drives into defined surroundings of the charging station;
automatically sending, by the charging station, a status message to the electric vehicle using the direct wireless communication link;
receiving, by the electric vehicle, the status message at the electric vehicle;
displaying, by the electric vehicle, contents of the status message; and
generating, by the electric vehicle, a charging request of the electric vehicle.

2. The method according to claim 1, wherein the direct wireless communication link is a Bluetooth link and a range of the direct wireless communication link defines the defined surroundings of the charging station.

3. The method according to claim 1, wherein the status message indicates an occupancy of the charging station and includes a waiting list.

4. The method according to claim 3, wherein the status message indicates an arrival time of the electric vehicle, a waiting time of the electric vehicle, and a state of charge of another electric vehicle.

5. The method according to claim 3, further comprising:
sending, by the electric vehicle, a reply message to the charging station;
adding, by the charging station, the electric vehicle to the waiting list if the reply message indicates the charging request of the electric vehicle; and
sending, by the charging station, a confirmation message to the electric vehicle if the reply message indicates the charging request of the electric vehicle.

6. The method according to claim 5, further comprising:
sending, by the electric vehicle, a cancellation message corresponding to the confirmation message to the charging station;
receiving, by the charging station, the cancellation message;
deleting, by the charging station, the electric vehicle from the waiting list; and
sending, by the charging station, one or more changed status messages that have been changed as a result of the deleting to another electric vehicle behind the electric vehicle in the waiting list.

7. The method according to claim 3, further comprising:
sending, by the charging station, a changed status message to another electric vehicle behind the electric vehicle in the waiting list when charging of the electric vehicle is finished.

8. The method according to claim 1, further comprising:
providing, by the charging station, a separate waiting list for each of a plurality of charging ports of the charging station, wherein the status message indicates an identifier of one of the plurality of charging ports of the charging station.

9. A charging station for an electric vehicle, the charging station comprising:
at least one charging port; and
a communication device coupled to the at least one charging port,
wherein the communication device, in operation,
automatically provides a direct wireless communication link between the charging station and the electric vehicle when the electric vehicle drives into defined surroundings of the charging station,
automatically sends a status message to the electric vehicle using the direct wireless communication link, and
receives a charging request of the electric vehicle, and
wherein the at least one charging port, in operation, charges the electric vehicle in response to the communication device receiving the charging request.

10. An electric vehicle, comprising:
a communication device; and
an interface device coupled to the communication device,
wherein the communication device, in operation,
automatically provides a direct wireless communication link between a charging station and the electric vehicle when the electric vehicle drives into defined surroundings of the charging station,
receives a status message from the charging station, and
sends a charging request of the electric vehicle, and
wherein the interface device, in operation,
displays contents of the status message, and
generates the charging request of the electric vehicle.
